(19) United States
(12) Patent Application Publication
(10) Pub. No.: US 2013/0315214 A1
(43) Pub. Date: Nov. 28, 2013

(54) Timing Advance Without Random Access Channel Access

(71) Applicants: Wei Bai, Bejing (CN); Jing Han, Bejing (CN); Haiming Wang, Beijing (CN)

(72) Inventors: Wei Bai, Bejing (CN); Jing Han, Bejing (CN); Haiming Wang, Beijing (CN)

(21) Appl. No.: 13/981,615

(22) PCT Filed: Feb. 1, 2011
(86) PCT No.: PCT/CN2011/070874

§ 371 Date: Aug. 16, 2013

(51) Int. Cl. H04W 72/04

(52) U.S. Cl. CPC H04W 72/0446
USPC 370/336

(57) ABSTRACT

A timing advance TA for a second component carrier CC is determined in dependence on a difference value that is indicated in wireless signaling between a network and a user equipment UE, in which the second CC and a first CC is allocated to the UE simultaneously. The determined TA is utilized to synchronize wireless communications on the second CC between the network and the UE. In exemplary embodiments: the difference value is a difference between times at which downlink transmissions were sent on the first and second CCs, and determining comprises solving for the TA for the second CC utilizing the signaled difference value in at least one algorithm; the difference value may be signaled in a MAC message or via RRC signaling, and the second CC may be an extension carrier. Apparatus, methods and programs are detailed for the UE and for the network access node/eNB.

### TECHNICAL FIELD

The exemplary and non-limiting embodiments of this invention relate generally to wireless communication systems, methods, devices and computer programs and, more specifically, relate to synchronization between user equipments/mobile terminals and wireless networks/access nodes utilizing multiple (e.g., primary and secondary) component carriers or cells of a carrier aggregation.

### BACKGROUND

The following abbreviations that may be found in the specification and/or the drawing figures are defined as follows:
3GPP third generation partnership project
CA carrier aggregation
CC component carrier
CE control element
DL downlink (node B towards UE)
eNB node B/base station in an E-UTRAN system
E-UTRAN evolved UTRAN (LTE)
LTE long term evolution
LTE-A LTE-Advanced
MAC medium access control
PCC primary component carrier
PRACH physical random access channel
RACH random access channel
RRC radio resource control
SIB system information block
TA timing advance
UE user equipment
UL uplink (UE towards node B/eNB)
UTRAN universal terrestrial radio access network

The LTE-Advanced wireless system aims to provide enhanced services by means of higher data rates and lower latency with reduced cost. Carrier aggregation (CA) is one technology LTE-Advanced intends to employ for improving the data rate. FIG. 1A illustrates the CA concept: the whole bandwidth of the wireless system is divided into two or more component carriers (CCs), of which FIG. 1A shows five CCs by example. At least one CC is configured to serve legacy UEs. Release 10 and later UEs are to be capable of monitoring/using multiple CCs, and so the wireless network is able to assign two or more CCs simultaneously as active for a single UE.

This enables the network greater scheduling flexibility by giving it the ability to allocate channels to the same UE on any one or more of the multiple CCs assigned to a given UE. In the case multiple CCs are assigned and active for a UE, one of the assigned CCs will be the UE's primary CC and the other(s) will be secondary CC(s). The UE's secondary CC(s) is/are also sometimes termed an extension carrier.

For Release 10, 3GPP has agreed that there will be only intra-band CA for the UL and one timing advance (TA) for all the UL CCs. But in Release 11 and beyond, when taking inter-band CA into deployment, as well as the cases of radio remote head (RRH) and repeaters (which are conceptually similar to relay stations for the purposes herein), multiple TAs will be necessary.

By way of background, for Releases 8/9/10 the only way for a UE which was not yet synchronized with a serving eNB to measure the timing advance was by accessing the random access channel (RACH). For Release 10, it was also agreed that random access will only be performed on the UE's primary CC, also termed its PCell, and so the UE was not required to know the RACH configuration on any secondary CCs, termed the SCell or SCells.

For Release 11 and beyond, when multiple TA is introduced there must be some means by which the UE can get the TA value for its SCell or SCells. Simply requiring the UE to utilize the RACH procedure to learn the TA on an SCell would require that the RACH configuration on the SCell be indicated to the UE somehow, and also this would lead to some changes to the current SCell parameter structure.

An additional problem arises in that in Release 10, RACH failure is recognized as a trigger condition for radio link failure (RLF). This followed from RACH being performed only on the PCell, but if the UE hypothetically also had RACH access on the SCell there would need for further standardization as to what would be a trigger to indicate UL RLF. These more nuanced issues are in addition to the straightforward ones: if the UE is to get the SCell TA on an SCell RACH there would necessarily be an increase to RACH overhead, meaning a higher load on the SCell RACH due to a higher number of UEs accessing it and also greater potential for delay on the RACH since more UEs would be competing for a slot on it. Currently the common view within the 3GPP community is there will be no RACH configuration on any extension carrier.

Exemplary embodiments detailed herein address the problem of synchronizing UL and DL messages when two different CCs are not necessarily tied to the same timing.

### SUMMARY

The foregoing and other problems are overcome, and other advantages are realized, by the use of the exemplary embodiments of this invention.

In a first exemplary embodiment of the invention there is an apparatus comprising at least one processor and at least one memory storing a computer program. In this embodiment the at least one memory with the computer program is configured with the at least one processor to cause the apparatus to at least: determine a timing advance for a second component carrier in dependence on a difference value that is indicated in wireless signaling between a network and a user equipment, in which the second component carrier and a first component carrier is allocated to the user equipment simultaneously; and utilize the determined timing advance to synchronize wireless communications on the second component carrier between the network and the user equipment.

100111 In a second exemplary embodiment of the invention there is a method comprising: determining a timing advance for a second component carrier in dependence on a difference value that is indicated in wireless signaling between a network and a user equipment, in which the second component carrier and a first component carrier is allocated to the user equipment simultaneously; and utilizing the determined timing advance to synchronize wireless communications on the second component carrier between the network and the user equipment.

In a third exemplary embodiment of the invention there is a computer readable memory storing a computer program, in which the computer program comprises: code for determining a timing advance for a second component carrier in dependence on a difference value that is indicated in wireless signaling between a network and a user equipment, in which the second component carrier and a first component carrier is allocated to the user equipment simultaneously; and code for utilizing the determined timing advance to synchronize wireless communications on the second component carrier between the network and the user equipment.

These and other embodiments and aspects are detailed below with particularity.

### BRIEF DESCRIPTION OF THE DRAWINGS

FIG. 1A is a schematic diagram illustrating a wireless system utilizing carrier aggregation, in which there are five component carriers or cells shown for which a user equipment might be allocated multiple component carriers/cells simultaneously.

FIG. 1B is a reproduction of FIG. 8.1-1 “Uplink-downlink timing relation” from 3GPP TS 36.211 v10.0.0 (2010-12).

FIG. 2A is a signaling diagram similar to FIG. 1A showing timing relation between various uplink and downlink messages.

FIG. 2B is similar to FIG. 2A but showing the timing relations for the messages on a primary and a secondary cell such as in FIG. 1B.

FIG. 3 is a schematic diagram of a two-byte MAC-layer control element for signaling to the UE the timing adjustment for the secondary component carrier/cell.

FIGS. 4-5 are logic flow diagrams that illustrates the operation of a method, and a result of execution of computer program instructions embodied on a computer readable memory, in accordance with particular embodiments of the invention from the perspective of the UE and the eNB, respectively

FIG. 6 is a logic flow diagram that illustrates the operation of a method, and a result of execution of computer program instructions embodied on a computer readable memory, in accordance with the exemplary embodiments of this invention.

FIG. 7 is a simplified block diagram of the UE in communication with a wireless network illustrated as an eNB and a serving gateway SGW, which are exemplary electronic devices suitable for use in practicing the exemplary embodiments of this invention.

### DETAILED DESCRIPTION

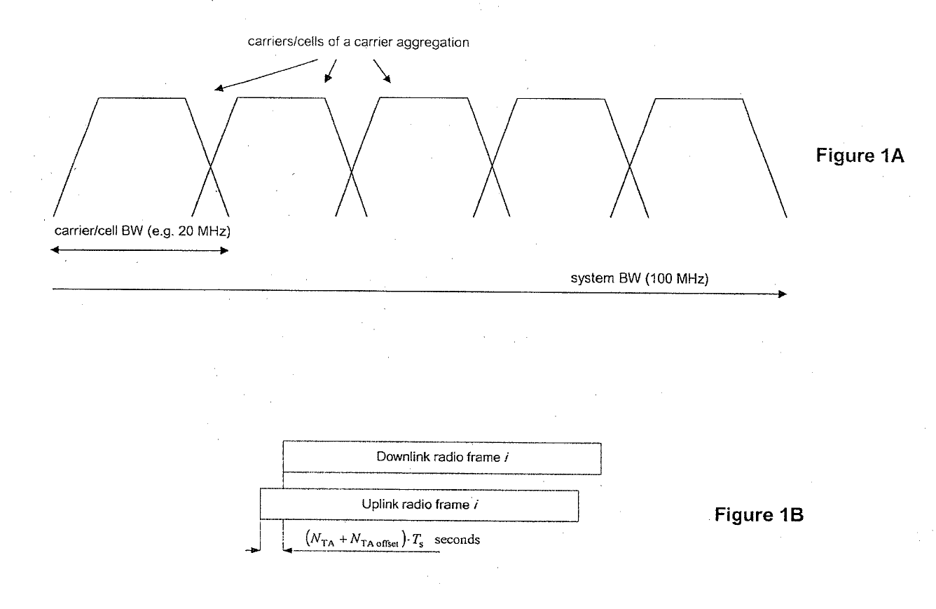

Consider the synchronization problem from the perspective of the access node, or eNB in an E-UTRAN system. The eNB needs the signals from all the user equipments UEs to arrive at the same time. The E-UTRAN system enables this by using a timing advance TA to control timing of the UE's UL transmissions. This TA also compensates for delay in the signal propagating from the sending UE to the receiving eNB. Specifically, 3GPP TS 36.211 v10.0.0 (2010-12) from which FIG. 1B is taken sets forth that transmission of the uplink radio frame number i from the UE shall start (N_{TA}+N_{TA offset})×T_{S} seconds before the start of the corresponding downlink radio frame at the UE, where 0≦N_{TA}≦20512, N_{TA offset}=0 for frame structure type 1 and N_{TA offset}=624 for frame structure type 2. Note that not all slots in a radio frame may be transmitted; for example in the time division duplex (TDD) mode only a subset of the slots in a radio frame are transmitted.

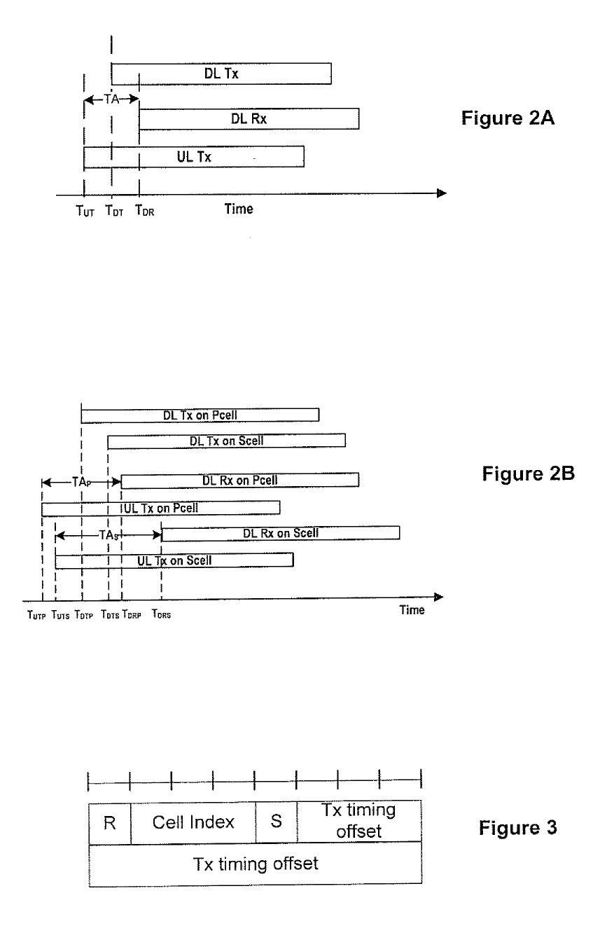

The UL and the DL transmissions between the same eNB (or radio head/repeater/relay) and UE have the same propagation path and speed. So from the e-NB's point of view, it will control the time at which it receives the UL transmission so as to align with the DL transmission timing. Therefore the timing difference between a DL transmission sent by the e-NB and an UL transmission sent by the UE should be the same as the difference between the DL reception at the UE and DL transmission from the e-NB. This is shown graphically at FIG. 2A, where the timing values refer to the time at which the relevant transmission is sent or received. The difference [T_{UT}−T_{DT}] between the time T_{DT} at which the eNB sends the DL transmission and the time T_{UT} at which the UE sends its UL transmission is the same as the difference [T_{DT}−T_{DR}] between the time T_{DT} and the time T_{DR} at which the UE receives the eNB's DL transmission. The timing advance is the round trip time, and equation (1) below expresses the TA and the equivalence of the timing differences explained above.

TA=T_{DR}−T_{UT}

T_{DT}−T_{UT}=T_{DR}−T_{DT} (1)

From equation (1), it follows that TA=2* (T_{DR}−T_{DT}).

When CA is introduced, it may be that not all CCs assigned for the UE are on the same timing, and so the TA on one CC is not valid for another CC on which the UE is communicating simultaneously. In this case the UE will need to adjust the UL transmission timing on the second CC in order to assure its UL transmissions are synchronized for the eNB (or other reception node such as a repeater). The example below assumes that in CA, at the e-NB side the different CCs/cells may have different

DL transmission timing, and at the UE side the different CCs/cells may have different DL reception timing and UL transmission timing.

If we term one of the CCs as the UE's primary cell PCell, and the other asynchronous CC as the UE's secondary cell SCell, then the timing relation shown by example at FIG. 2B graphically illustrates the multiple timing advances. Note that in FIG. 2B, the UL and DL radio frames on the UE's PCell are the same as those shown in FIG. 2A; but FIG. 2B shows also the similar radio frames transmitted on the UE's SCell which are asynchronous with those on the PCell.

Specifically, for the PCell the difference [T_{UTP}−T_{DTP}] between the time T_{DTP} at which the eNB sends the DL transmission on the PCell and the time T_{UTP} at which the UE sends its UL transmission on the PCell is the same as the difference [T_{DTP}−T_{DRP}] between the time T_{DTP} and the time T_{DRP} at which the UE receives the eNB's DL transmission on the PCell. Given the assumptions above that the timing structure on the SCell is similar to that on the PCell, then it follows that for the SCell the difference [T_{UTS}−T_{DTS}] between the time T_{DTS} at which the eNB sends the DL transmission on the SCell and the time T_{UTS} at which the UE sends its UL transmission on the SCell is the same as the difference [T_{DTS}−T_{DRS}] between the time T_{DTS} and the time T_{DRS} at which the UE receives the eNB's DL transmission on the SCell.

The timing advance TA_{P} on the PCell and the timing advance TA_{S} on the SCell are shown at equation (2) below.

TA_{P}=T_{DRP}−T_{UTP}=2*(T_{DRP}−T_{DTP})

TA_{S}=T_{DRS}−T_{UTS}=2*(T_{DRS}−T_{DTS}) (2)

Substituting equivalents and manipulating from equation (2) then yield the relation TA_{P}−TA_{S}=2*[(T_{DRP}−T_{DRS})−(T_{DTP}−T_{DTS})]. This means that the UE could determine the DL reception timing difference between two cells by itself, without having to access any RACH for the secondary cell. So as long as the UE could know the DL transmission timing difference between the two cells, the UE could simply add to or subtract from the timing advance TA_{P} on the PCell that timing ‘difference value’ or ‘TA offset’ that is relevant for the specific SCell in question.

While these examples are in the context of TA_{P} being the TA for the UE's primary carrier, these teachings are equally valid for the more general case in which TA_{P} represents a carrier for which the UE has a valid timing advance. In this more general case, all of the equation variables with subscript P refer to the carrier for which the valid TA_{P} applies.

In one embodiment the signaled difference value is [T_{DTP}−T_{DTS}]. This allows the UE to know the time at which the eNB will transmit its DL TX on the SCell, tune its receiver there in time and learn the T_{DRX} as the time the UE receives that DL transmission. TA_{S} and T_{UTS} are then solved by the above equations.

In still another embodiment the signaled difference value is [TA_{P}−TA_{S}]. In this case the UE would listen on the SCell for the DL transmission and learn the T_{DRS} from its reception time, then compute D_{UTS} also using the equations above. In most cases for this embodiment though, the UE would be listening for the DL TX for a somewhat longer time window than for the above embodiment in which [T_{DTP}−T_{DTS}] is the signaled difference value.

Whether CA or not the UE already must obtain the timing advance TA_{P} on the PCell, and so by the above example there is no additional back and forth signaling between the network and the UE in order for the UE to obtain the TA_{S} on the specific SCell; the UE simply calculates it from the TA_{P} and the signaled difference or offset value as noted above.

The above example is non-limiting to the more general teachings herein. As another example, for the case in which there is no DL transmission timing difference, then the e-NB would not need to indicate the timing offset to the UE and the UE could just derive the TA value on the specific SCell itself. In this case the lack of explicit signaling of the difference which the UE is expecting is an indication that the timing difference is zero. Stated generally, the e-NB indicates to the UE the DL transmission timing difference between the PCell and the SCell, if any.

In an additional example, if it comes to pass that the PCell is to be the timing reference, then from the previous analysis the UE could derive that from the same equation TA_{P}−TA_{S}=2* [(T_{DRP}−T_{DRS})−(T_{DTP}−T_{DTS})]+(T_{DRS}−T_{DRP}), substituting the PCell values for the SCell variables where appropriate for the PCell as reference.

So in an exemplary embodiment, once the eNB informs the UE of the DL transmission timing difference between the PCell and the SCell, then the UE could simply derive the TA_{S} on the SCell as long as the TA_{P} on the PCell is valid.

In the current LTE system, one TA step is 16*Ts. Therefore the step of the DL transmission timing difference should be no smaller than 16*Ts. In discussions for LTE Release 10 it was agreed that CCs which could be aggregated should be frame aligned (system frame number SFN aligned), so even if the e-NB has different DL transmission timing it should not have a difference larger than one subframe.

There are different implementations for how the eNB can signal the timing difference. In one embodiment the eNB uses a medium access control (MAC) control element (CE) to indicate the timing difference. One exemplary MAC CE is shown at FIG. 3, two bytes 301, 302 (eight bits each) which are byte-aligned as illustrated by the rows of FIG. 3. In the FIG. 3 MAC CE embodiment there is one bit R which is not specifically used for the difference signaling purposes and so is reserved for future or other uses, there are three bits for indicating the cell index of the SCell to which the UE should apply the signaled difference, and there are eleven bits for indicting the timing difference itself. These eleven bits of the MAC CE for indicating the timing difference (2¹¹*16*Ts=32768*Ts) enable it to cover up to one LTE subframe (30720*Ts), meaning the timing difference is indicated as a multiple of 16*T_{S}. Of course other implementations may use a different number of bits to indicate the timing difference. In all the above implementations and as shown at FIG. 3, there is additionally one bit S for indicating whether the difference is positive or negative, and the bits used to signal the difference value are spread across two bytes.

In another embodiment the eNB signals the timing difference using the RRC signaling which is used to add and/or reconfigure the SCell itself for the UE.

Now assuming the UE has received and properly received and decoded the difference value signaled by the eNB, he UE can calculate the TA value on the SCell based on any of the following equations:

TA_{S}=TA_{P}−2*[(T_{DRP}−T_{DRS})−(T_{DTP}−T_{DTS})] a.

TA_{S}=TA_{P}−2*[(T_{DRP}−T_{DRS})] b.

TA_{S}=TA_{P}+(T_{DRS}−T_{DRP})+2*(T_{DTP}−T_{DTS})] c.

Equation a may be used for example if the SIB-2 linked SCell is used as the UE's timing reference. Equation b may be used for example if there is no DL transmission timing difference. In this case the UE could just calculate the TA value on the SCell without any difference signaling from the eNB. Equation c may be used for example if the PCell is used as the UE's timing reference. In an embodiment the UE stores each of these equations or algorithms in its local memory and selects the one fitting for its particular situation at any given time. The ‘timing reference’ noted above refers to which DL reception timing on which CC serves as the UE's timing reference, since for multiple CCs the different DL receptions may be received at different times.

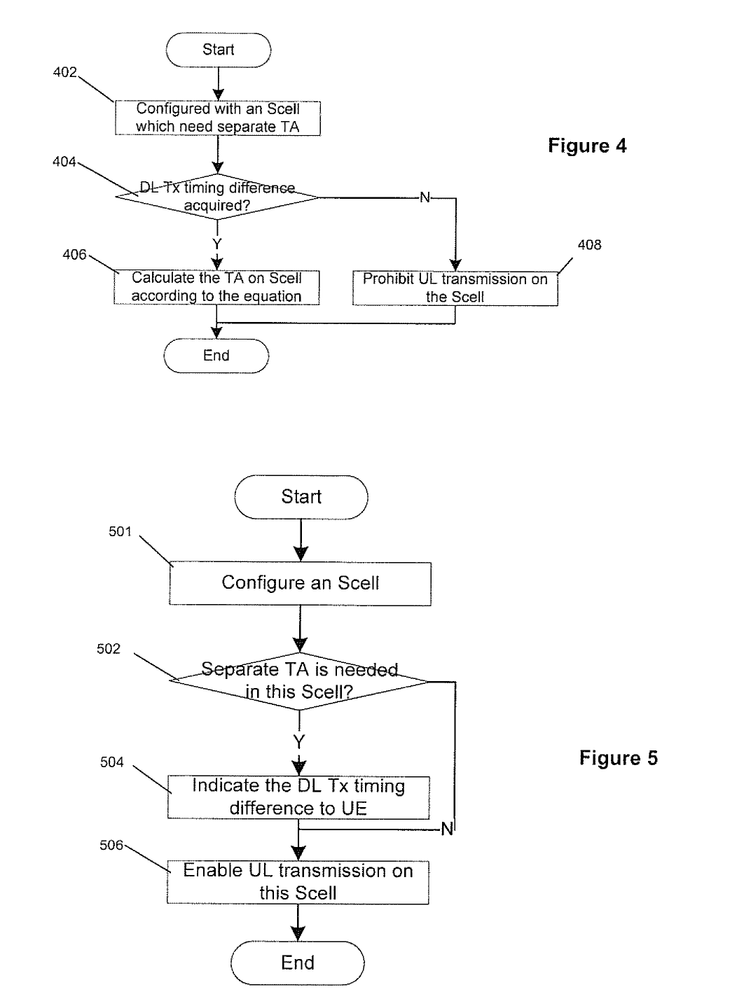

FIG. 4 is a logic flow diagram illustrating an exemplary but non-limiting embodiment of the invention from the perspective of the UE. At block 402 the UE is configured with an SCell which needs a separate TA as compared to the TA on the UE's PCell. The SCell may be a backward-compatible (e.g., Release 8) CC of a CA system, or it may be an extension carrier. From this the UE knows not to send any UL transmission until it acquires the TA for the SCell. At block 404 the UE acquires the DL TX timing difference which the eNB signals. If the UE properly receives and decodes that DL TX difference at block 404, then the process proceeds to block 406 at which the UE calculates the TA on the SCell according to the appropriate equation a, b, or c above. If instead the UE does not properly receive and decode the DL TX timing difference at block 404, then the process continues at block 408 in which the UE is prohibited from sending UL transmissions on the SCell (since there is a separate TA from block 402).

FIG. 5 is a logic flow diagram illustrating an exemplary but non-limiting embodiment of the invention from the perspective of the eNB. At block 501 the eNB configures a UE with an SCell. The SCell may be a backward-compatible CC of a CA system, or it may be an extension carrier, and this configuring may be upon first connection of the UE to that serving eNB (via handover or RACH process) in which the eNB configures the UE with a PCell and an SCell at the same time, or it may be re-configuring the UE with the SCell in addition to a previously configured PCell. At block 502 the eNB checks whether the newly configured SCell needs a separate TA as compared to that same UE's PCell. If yes at block 502 then the process continues at block 504 and the eNB sends the DL TX timing difference to the UE. Assuming the UE properly receives and decodes that DL TX difference which the eNB sent at block 504, then the process proceeds from block 504 to block 506 at which time the eNB considers the UE enabled for UL transmissions on the SCell and so has that greater flexibility for scheduling radio resources for that UE. By example, the eNB can know whether the UE properly received and decoded the difference sent at block 504 via acknowledgement messaging, such as a physical ACK message if the eNB sends the timing difference value in a MAC CE or a RRC reconfiguration complete message if the eNB sends the timing difference value in RRC signaling which also assigns the SCell to the UE.

Note also that if it is determined at block 502 that a separate TA for the SCell is not needed as compared to the TA on the UE's PCell, then the signaled indication at block 504 is bypassed in an exemplary embodiment and the process flows from block 502 directly to block 506 as shown since the UE can simply use the TA_{P} on the SCell. In this exemplary embodiment the lack of eNB explicit signaling of the difference value (DL TX timing difference) at block 504 inherently indicates that the UE is to consider the TA_{S} the same as the TA_{P}.

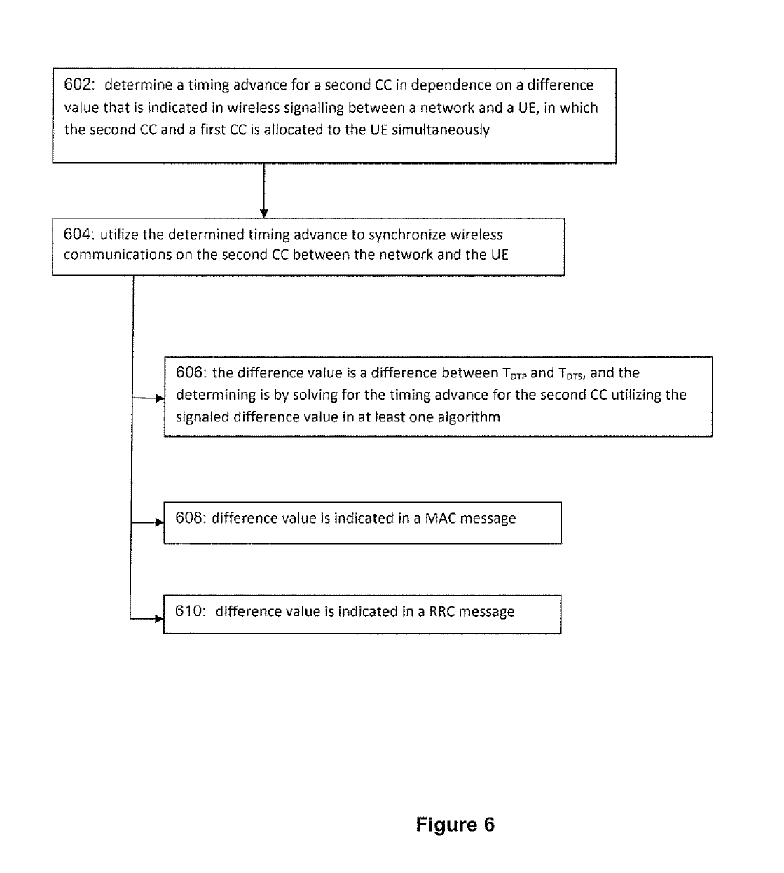

FIG. 6 is a logic flow diagram which describes an exemplary embodiment of the invention in a manner which may be from the perspective of the UE or of the eNB, since the eNB must synchronize its receiver to the UE's UL transmissions on the SCell similar to the UE synchronizing its transmitter to send on that SCell. FIG. 6 may be considered to illustrate the operation of a method, and a result of execution of a computer program stored in a computer readable memory, and a specific manner in which components of an electronic device are configured to cause that electronic device to operate. The various blocks shown in FIG. 6 may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

At block 602 the UE or eNB determines a timing advance for a second CC in dependence on a difference value that is indicated in wireless signaling between a network and a UE, in which the second CC and a first CC is allocated to the UE simultaneously. This is not to imply that the first and second CC must in all cases be allocated at the same time to the UE, only that the UE has allocated to it at a given time instant both the first and the second CC. By example the second CC may be a SCell in a CA, or it may be an extension carrier. As noted above, the first CC may be the UE's primary CC or any other CC for which the UE has a valid TA. At block 604 the process continues by utilizing the determined timing advance to synchronize wireless communications on the second CC between the network and the user equipment.

Further elements of FIG. 6 are directed toward more specific embodiments and may or may not be present in conjunction with blocks 602 and 604. At block 606 the difference value is a difference between times at which downlink transmissions were sent on the first and on the second CCs (e.g., the difference between T_{DTP} and T_{DTS}), and the determining of block 602 comprises solving for the timing advance for the second component carrier utilizing the signaled difference value in at least one algorithm. By example, the at least one algorithm is one of those annotated above as equations a, b and c.

At block 608 the difference value is indicated in a MAC message wirelessly signaled from the network to the UE, such as the MAC CE of FIG. 3 which has an additional indication of whether the value is positive or negative and an identifier of the second CC, and in a particular embodiment has the various signaling bits arranged according to the two bytes shown at FIG. 3. At block 610 the difference value is indicated in a RRC message wirelessly signaled from the network to the UE, for example the RRC message which allocates the second CC to the UE.

One technical effect and advantage of these exemplary embodiments is that they align with current agreements in LTE Release 10, in that there is still only a RACH configured on the PCell for any given UE and therefore no need to tell the UE of any RACH configuration on the SCell. This is seen for typical implementations at least to greatly reduce the RACH overhead, as opposed to having an SCell RACH configuration to bet the TA_{S}. Further, these exemplary embodiments are more robust than the SCell RACH alternative because the timing difference could use a hybrid automatic repeat request HARQ process to assure reliable transmission. Another advantage and another technical effect is that for these exemplary embodiments there is no impact to the current UL radio link failure trigger conditions, noted in the background section above. And an additional technical effect is that the time it takes for the UE to acquire the TA_{S} is greatly reduced for these exemplary embodiments as compared to a SCell RACH process. So these exemplary embodiments exhibit an efficient and robust solution for CA with multiple timing advances, and is also equally efficient and robust for the case that an extension carrier might be introduced since even the RACH option is not available for an extension carrier.

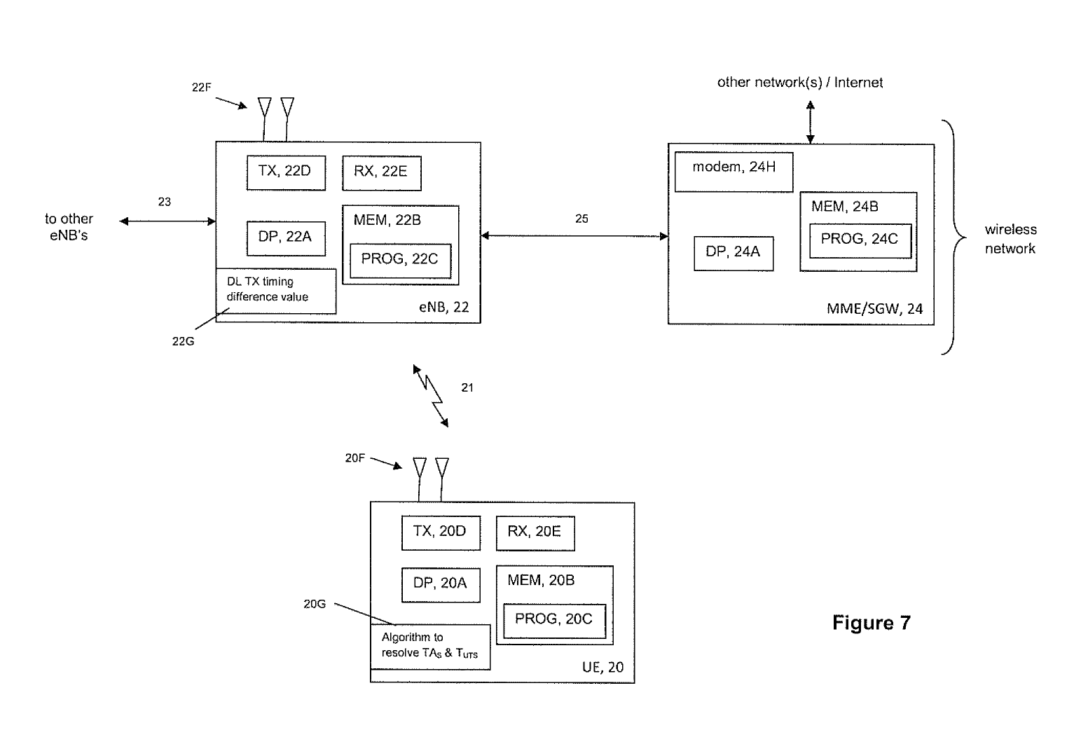

Reference is now made to FIG. 7 for illustrating a simplified block diagram of various electronic devices and apparatus that are suitable for use in practicing the exemplary embodiments of this invention. In FIG. 7 a wireless network (eNB 22 and mobility management entity MME/serving gateway SGW 24) is adapted for communication over a wireless link 21 with an apparatus, such as a mobile terminal or UE 20, via a network access node, such as a base or relay station or more specifically an eNB 22, The network may include a network control element MME/SGW 24, which provides connectivity with further networks (e.g., a publicly switched telephone network PSTN and/or a data communications network/Internet).

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the eNB 22 via one or more antennas 20F. Also stored in the MEM 2013 at reference number 20G is the algorithm which the UE 20 utilizes to acquire TA_{S} and T_{UTS} for use on the SCell while substituting in the difference value it received from the eNB 22.

The eNB 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F. There is a data and/or control path 25 coupling the eNB 22 with the MME/SGW 24, and another data and/or control path 23 coupling the eNB 22 to other eNB's/access nodes. The eNB 22 stores the DL TX difference value which it signals in its own MEM 22B.

Similarly, the MME/SGW 24 includes processing means such as at least one data processor (DP) 24A, storing means such as at least one computer-readable memory (MEM) 24B storing at least one computer program (PROG) 24C, and communicating means such as a modem 24H for bidirectional wireless communications with the eNB 22 via the data/control path 25. While not particularly illustrated for the UE 20 or eNB 22, those devices are also assumed to include as part of their wireless communicating means a modem which may be inbuilt on an RF front end chip within those devices 20, 22 and which also carries the TX 20D/22D and the RX 20E/22E.

At least one of the PROGs 20C in the UE 20 is assumed to include program instructions that, when executed by the associated DP 20A, enable the device to operate in accordance with the exemplary embodiments of this invention, as detailed above. The eNB 22 and MME/SGW 24 may also have software to implement certain aspects of these teachings for signaling the timing difference and synchronizing the UE's UL transmissions to the TA_{S}. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire UE 20 or eNB 22, but exemplary embodiments may be implemented by one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 20B and 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A and 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the E-UTRAN system, it should be appreciated that the exemplary embodiments of this invention are not limited for use with only this one particular type of wireless communication system, and that they may be used to advantage in other wireless communication systems such as for example UTRAN, GERAN and GSM and others so long as there are different carriers operating on different timing which might be assigned to a UE.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus, comprising:
at least one processor; and
at least one memory storing a computer program;
in which the at least one memory with the computer program is configured with the at least one processor to cause the apparatus to at least;
determine a timing advance for a second component carrier in dependence on a difference value that is indicated in wireless signaling between a network and a user equipment, in which the second component carrier and a first component carrier is allocated to the user equipment simultaneously; and
utilize the determined timing advance to synchronize wireless communications on the second component carrier between the network and the user equipment.

2. The apparatus according to claim 1, wherein the difference value is a difference between times at which downlink transmissions were sent on the first and on the second component carriers, and the timing advance is determined b at least utilizing the signaled difference value in at least one algorithm stored in the memory to solve for the timing advance for the second component carrier.

3. The apparatus according to claim 2, in which the at least one algorithm comprises at least one of:
TA_{S}=TA_{P}−2*[(T_{DRP}−T_{DRS})−(T_{DTP}−T_{DTS})];
TA_{S}=TA_{P}−2*(T_{DRP}−T_{DRS}); and
TA_{S}=TA_{P}+(T_{DRS}−T_{DRP})+2*(T_{DTP}−T_{DTS});
in which:
TA_{S} is the timing advance for the second component carrier which is a secondary component carrier for the user equipment;
TA_{P} is the timing advance for the first component carrier which is a carrier for which the user equipment has a valid timing advance;
T_{DRP} is time at which a first downlink transmission was received on the first component carrier;
T_{DRS} is time at which a second downlink transmission was received on the second component carrier;
T_{DTP} is time at which the first downlink transmission was sent on the first component carrier; and
T_{DTS} is time at which the second downlink transmission was sent on the second component carrier.

4. The apparatus according to claim 1, in which the difference value is indicated in a medium access control MAC message wirelessly signaled from the network to the user equipment.

5. The apparatus according to claim 4, in which the difference value is indicated in the medium access control MAC message as a value and an additional indication of whether the value is positive or negative and an identifier of the second component carrier.

6. The apparatus according to claim 5, in which the MAC message comprises a MAC control element comprising two bytes; the difference value is expressed in a plurality of bits spread across the two bytes, and the additional indication and the identifier are expressed in bits lying within one of the bytes.

7. The apparatus according to claim 1, in which the difference value is indicated in a radio resource control RRC message wirelessly signaled from the network to the user equipment.

8. The apparatus according to claim 1, in which the apparatus comprises the user equipment or an access node of the network which is a cellular network.

9. The apparatus according to claim 8, in which the apparatus further comprises at least one antenna for wirelessly signaling the difference value.

10. A method, comprising:
determining a timing advance for a second component carrier in dependence on a difference value that is indicated in wireless signaling between a network and a user equipment, in which the second component carrier and a first component carrier is allocated to the user equipment simultaneously; and
utilizing the determined timing advance to synchronize wireless communications on the second component carrier between the network and the user equipment.

11. The method according to claim 10, wherein the difference value is a difference between times at which downlink transmissions were sent on the first and on the second component carriers, and determining comprises utilizing the signaled difference value in at least one algorithm stored in the memory to solve for the timing advance for the second component carrier.

12. The method according to claim 11, in which the at least one algorithm comprises at least one of:
TA_{S}=TA_{P}−2*[(T_{DRP}−T_{DRS})−(T_{DTP}−T_{DTS})];
TA_{S}=TA_{P}−2*(T_{DRP}−T_{DRS}); and
TA_{S}=TA_{P}+(T_{DRS}−T_{DRP})+2*(T_{DTP}−T_{DTS});
in which:
TA_{S} is the timing advance for the second component carrier which is a secondary component carrier for the user equipment;
TA_{P} is the timing advance liar the first component carrier which is a carrier liar which the user equipment has a valid timing advance;
T_{DRP} is time at which a first downlink transmission was received on the first component carrier;
T_{DRS} is time at which a second downlink transmission was received on the second component carrier;
T_{DTP} is time at which the first downlink transmission was sent on the first component carrier; and
T_{DTS} is time at which the second downlink transmission was sent on the second component carrier.

13. The method according to claim 10, in which the difference value is indicated in a medium access control MAC message wirelessly signaled from the network to the user equipment.

14. The method according to claim 13, in which the difference value is indicated in the medium access control MAC message as a value and an additional indication of whether the value is positive or negative and an identifier of the second component carrier,

15. The method according to claim 14, in which the MAC message comprises a MAC control element comprising two bytes, the difference value is expressed in a plurality of bits spread across the two bytes, and the additional indication and the identifier are expressed in bits lying within one of the bytes.

16. The method according to claim 10, in which the difference value is indicated in a radio resource control RRC message wirelessly signaled from the network to the user equipment.

17. The method according to claim 10, in which the method is executed by one of the user equipment and an access node of the network which is a cellular network.

18. A computer readable memory storing a computer program comprising:
code for determining a timing advance for a second component carrier in dependence on a difference value that is indicated in wireless signaling between a network and a user equipment, in which the second component carrier and a first component carrier is allocated to the user equipment simultaneously; and
code for utilizing the determined timing advance to synchronize wireless communications on the second component carrier between the network and the user equipment.

19. The computer readable memory according to claim 18, wherein the difference value is a difference between times at which downlink transmissions were sent on the first and on the second component carriers, and the code for determining comprises code for utilizing the signaled difference value in at least one algorithm stored in the memory to solve for the timing advance for the second component carrier.

20. The computer readable memory according to claim 19, in which the at least One algorithm composes at least one of:
TA_{S}=TA_{P}−2*[(T_{DRP}−T_{DRS})−(T_{DTP}−T_{DTS})];
TA_{S}=TA_{P}−2*(T_{DRP}−T_{DRS}); and
TA_{S}=TA_{P}+(T_{DRS}−T_{DRP})+2*(T_{DTP}−T_{DTS});
in which:
TA_{S} is the timing advance for the second component carrier which is a secondary component carrier for the user equipment;
TA_{P} is the timing advance for the first component carrier which is a carrier for which the user equipment has a valid timing advance;
T_{DRP} is time at which a first downlink transmission was received on the first component carrier;
T_{DRS} is time at which a second downlink transmission was received on the second component carrier;
T_{DTP} is time at which the first downlink transmission was sent on the first component carrier; and
T_{DTS} is time at which the second downlink transmission was sent on the second component carrier.

21. The computer readable memory according to claim 18, in which the difference value is indicated in a medium access control MAC message wirelessly signaled from the network to the user equipment.

22. The computer readable memory according to claim 21, in which the MAC message comprises a MAC control element comprising two bytes: the difference value is expressed in a plurality of bits spread across the two bytes, and the additional indication and the identifier are expressed in hits lying within one of the bytes.

23. The computer readable memory according to claim 18, in which the difference value is indicated in a radio resource control RRC message wirelessly signaled from the network to the user equipment.
